(19) United States
(12) Patent Application Publication
(10) Pub. No.: US 2015/0037001 A1
(43) Pub. Date: Feb. 5, 2015

(54) SOLUTION FOR IDENTIFYING A SOUND SOURCE IN AN IMAGE OR A SEQUENCE OF IMAGES

(71) Applicant: THOMSON LICENSING, Issy de Moulineaux (FR)

(72) Inventors: Marco Winter, Hannover (DE); Wolfram Putzke-Roeming, Hildesheim (DE); Joem Jachalsky, Wennigsen (DE)

(21) Appl. No.: 14/381,007

(22) PCT Filed: Feb. 11, 2013
(86) PCT No.: PCT/EP2013/052664

§ 371 Date: Aug. 26, 2014

(30) Foreign Application Priority Data
Feb. 29, 2012 (EP) 12305242.5
May 14, 2012 (EP) 12305533.7

(51) Int. Cl. H04N 21/4725; H04N 21/488; H04N 21/81; H04N 21/431

(52) U.S. Cl. CPC H04N 21/4725; H04N 21/4316; H04N 21/4884; H04N 21/8146; H04N 21/8133
USPC 386/240

(57) ABSTRACT

A method for identifying a sound source in an image or a sequence of images to be displayed is described. The method comprises:
retrieving the image or the sequence of images;
retrieving metadata provided for the image or the sequence of images, the metadata comprising at least one of information about a location of the sound source within the image or the sequence of images, information about position and size of a graphical identifier for identifying the sound source, and shape of the sound source;
including a graphical identifier for the sound source in the image or the sequence of images using the information included in the metadata; and
outputting the image or the sequence of images for display.

The present invention is related to a solution for identifying a sound source in an image or a sequence of images. More specifically, the invention is related to a solution for identifying a sound source in an image or a sequence of images using graphical identifiers, which can easily be recognized by a viewer.

In the following the identification of a sound source will be discussed in relation to image sequences, or simply ‘video’. Of course, it may likewise be done for single images. The solutions according to the invention are suitable for both applications.

In order to simplify the assignment of sub-titles to the correct person, U.S. 2006/0262219 proposes to place sub-titles close to the corresponding speaker. In addition to the placement of the sub-titles, also talk bubbles may be displayed and linked to the corresponding speaker using a graphical element. To this end positioning information, which is transmitted together with the sub-titles, is evaluated.

Though the above solution allows allocating the sub-titles to the speaker, i.e. to a sound source, it is apparently only applicable in case subtitles are available. Also, it is limited to speakers. Other types of sound sources cannot be identified.

It is an object of the present invention to propose a more flexible and advanced solution for identifying a sound source in an image or a sequence of images.

According to the invention, a method for identifying a sound source in an image or a sequence of images to be displayed comprises the steps of:
retrieving the image or the sequence of images;
retrieving metadata provided for the image or the sequence of images, the metadata comprising at least one of information about a location of the sound source within the image or the sequence of images, information about position and size of a graphical identifier for identifying the sound source, and shape of the sound source;
including a graphical identifier for the sound source in the image or the sequence of images using the information included in the metadata; and
outputting the image or the sequence of images for display.

Accordingly, an apparatus for playback of an image or a sequence of images comprises:
an input for retrieving the image or the sequence of images and for retrieving metadata provided for the image or the sequence of images, the metadata comprising at least one of information about a location of the sound source, information about position and size of a graphical identifier for identifying the sound source, and shape of the sound source;
means for including a graphical identifier for the sound source in the image or the sequence of images using the information included in the metadata; and
an output for outputting the image or the sequence of images for display.

The invention describes a number of solutions for visually identifying a sound source in an image or a sequence of images. For this purpose the information conveyed by the metadata comprises at least one of a location of a sound source, e.g. a speaker or any other sound source, information about position and size of a graphical identifier for highlighting the sound source, and shape of the sound source. Examples of such graphical identifiers are a halo located above the sound source, an aura arranged around the sound source, and a sequence of schematically indicated sound waves. The content transmitted by a broadcaster or a content provider is provided with metadata about the location and other data of the speaker or other sound sources. These metadata are then used to identify the speaker or the other sound source with the graphical identifier. The user has the option to activate these visual hints, e.g. using the remote control of a set top box.

According to a further aspect of the invention, a method for generating metadata for identifying a sound source in an image or a sequence of images to be displayed comprises the steps of:
determining at least one of information about a location of the sound source within the image or the sequence of images, information about position and size of a graphical identifier for identifying the sound source, and shape of the sound source; and
storing the determined information as metadata for the image or the sequence of images on a storage medium.

Accordingly, an apparatus for generating metadata for identifying a sound source in an image or a sequence of images to be displayed comprises:
a user interface for determining at least one of information about a location of the sound source within the image or the sequence of images, information about position and size of a graphical identifier for identifying the sound source, and shape of the sound source; and
an output for storing the determined information as metadata for the image or the sequence of images on a storage medium.

According to this aspect of the invention, a user or a content author has the possibility to interactively define information suitable for identifying a speaker and/or another sound source in the image or the sequence of images. The determined information is preferably shared with other users of the content, e.g. via the homepage of the content provider.

For a better understanding the invention shall now be explained in more detail in the following description with reference to the figures. It is understood that the invention is not limited to this exemplary embodiment and that specified features can also expediently be combined and/or modified without departing from the scope of the present invention as defined in the appended claims. In the figures:

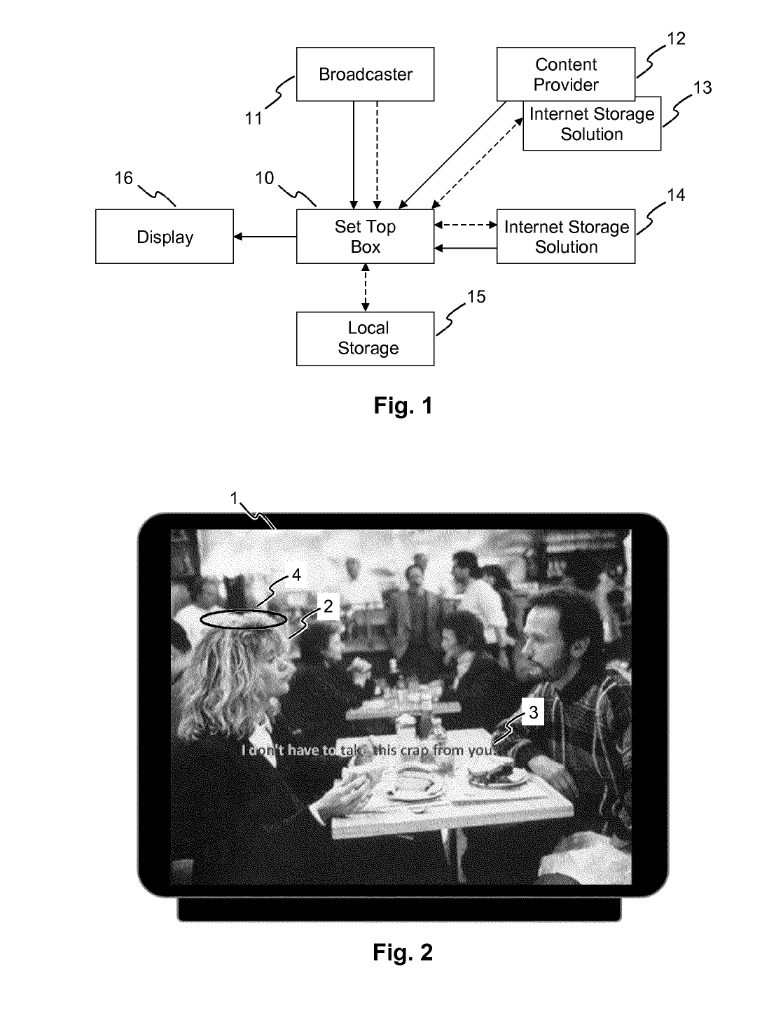

FIG. 1 schematically illustrates the interconnection of video, metadata, broadcaster, content provider, internet, user, and finally display;

FIG. 2 shows a sub-title associated to an object in the scene and a halo to identify the person who is speaking;

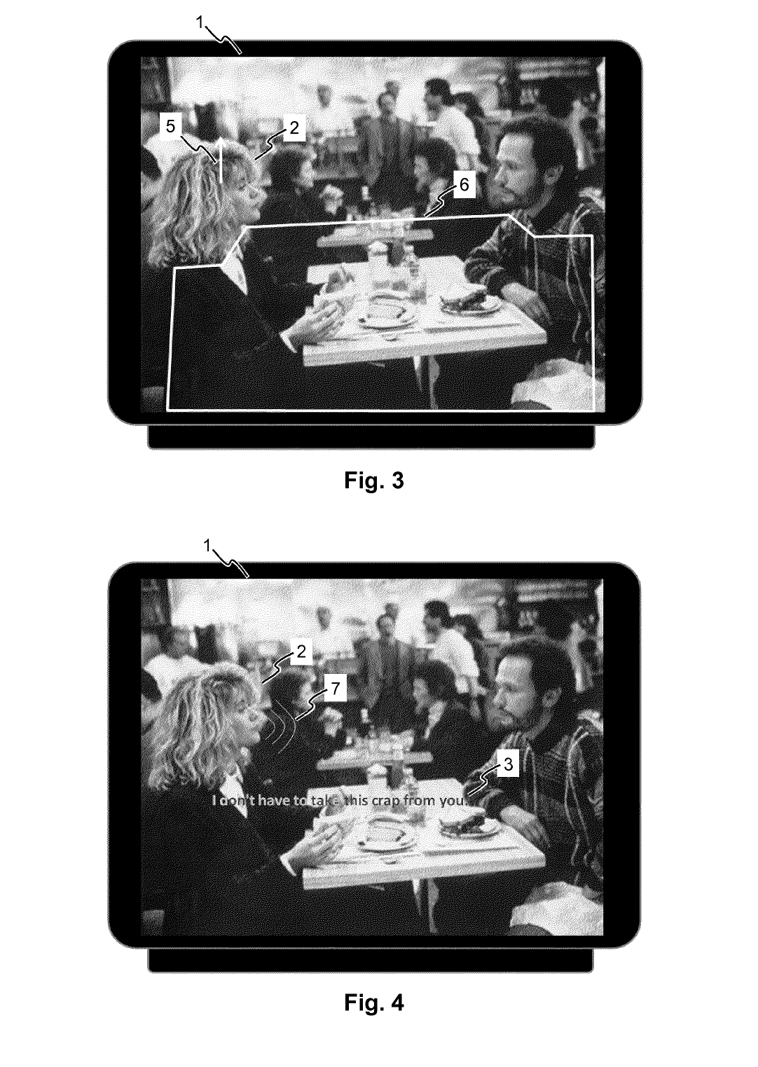

FIG. 3 illustrates special information indicated by metadata;

FIG. 4 shows an alternative solution for highlighting the person who is speaking using schematically indicated sound waves;

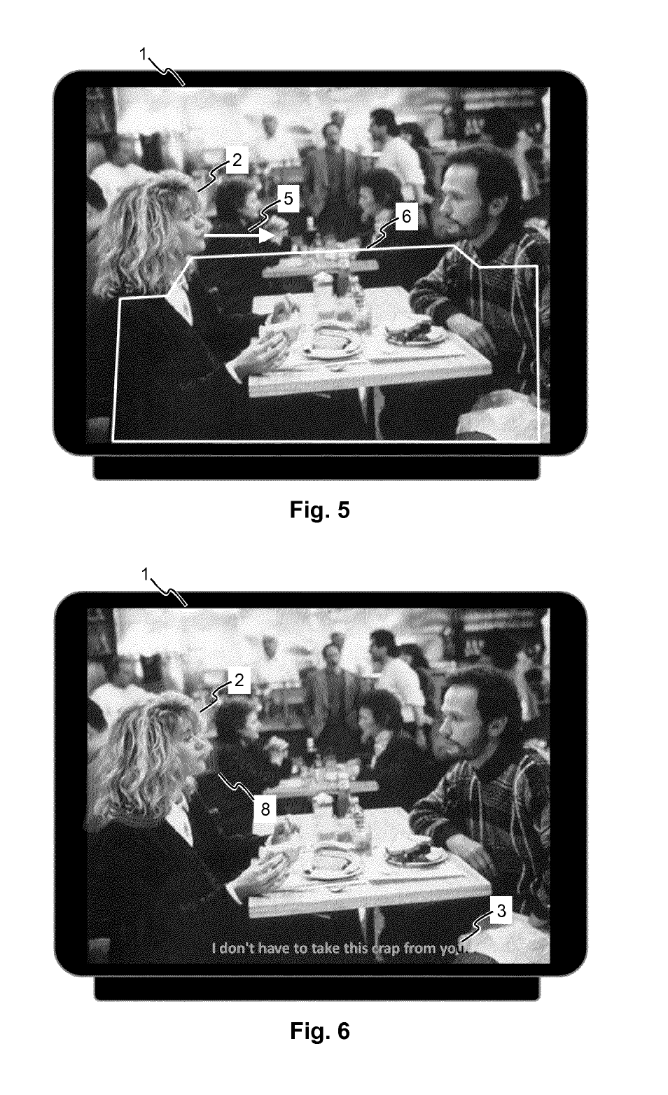

FIG. 5 illustrates special information indicated by metadata for the solution of FIG. 4;

FIG. 6 shows yet a further alternative solution for highlighting the person who is speaking using an aura;

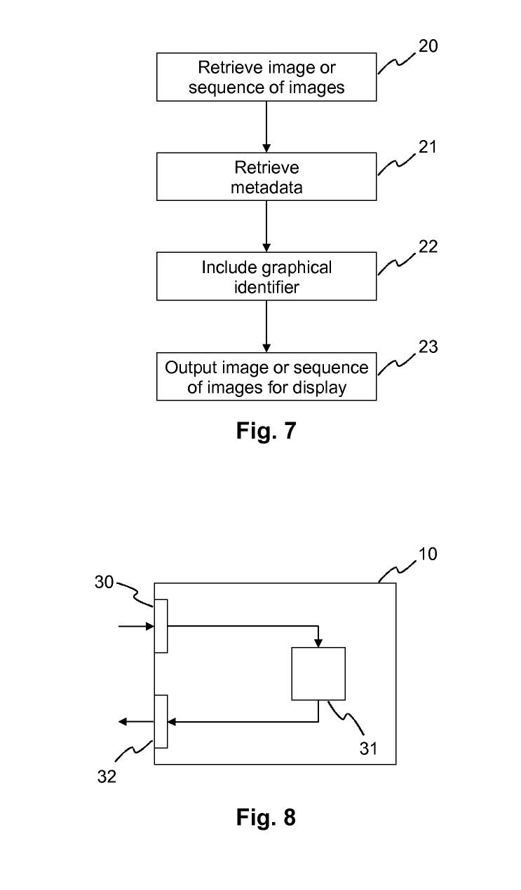

FIG. 7 schematically illustrates method for identifying a sound source in an image or a sequence of images according to the invention;

FIG. 8 schematically depicts an apparatus for performing the method of FIG. 7;

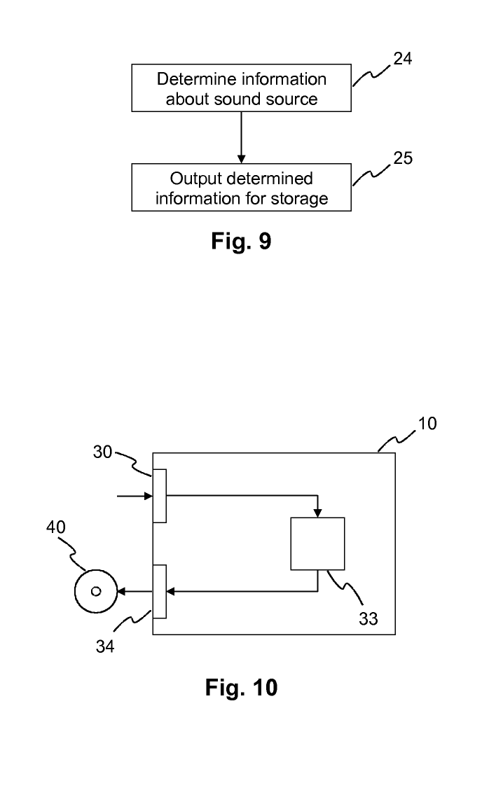

FIG. 9 schematically illustrates method for generating metadata for identifying a sound source in an image or a sequence of images according to the invention; and

FIG. 10 schematically depicts an apparatus for performing the method of FIG. 9.

FIG. 1 schematically illustrates the interconnection of video, metadata, broadcaster, content provider, internet, user, and finally display. In the figure, the transmission of content, i.e. video data, is designated by the solid arrows. The transmission of metadata is designated by the dashed arrows. Apparently, content plus the associated metadata will typically transmitted to the user's set top box 10 directly from a broadcaster 11. Of course, content and metadata may likewise be provided by the content provider 12. For example, the content and at least some or even all of the metadata may be stored on optical disks or other storage media, which are sold to the user. Additional metadata is then made available by the content provider 12 via an internet storage solution 13. Of course, also the content or the additional content may be provided via the internet storage solution 13. Similarly, both content and metadata may be provided via an internet storage solution 14 that is independent from the content provider 12. In addition, both the internet storage solution 13 provided by the content provider 12 as well as the independent internet storage solution 14 may offer the possibility to upload metadata from the user. Finally, metadata may be stored in and retrieved from a local storage 15 at the user side. In any case the content and the metadata are evaluated by the set top box 10 to generate an output on a display 16.

According to the invention, based on the metadata that are made available for the content, the user has the option to activate certain automatic visual hints to identify a person who is currently speaking, or to visualize sound. Preferably, the activation can be done using a remote control of the set top box.

A first solution for a visual hint is to place an additional halo 4 above the speaker 2 in order to emphasize the speaker 2. This is illustrated in FIG. 2. In this figure the sub-title 3 is additionally placed closer to the correct person 2. Of course, the halo 4 can likewise be used with the normal placement of the sub-title 3 at the bottom of the scene 1.

FIG. 3 schematically illustrates some special information indicated by the metadata that are preferably made available in order to achieve the visual hints. First, there is an arrow or vector 5 from the center of the head to the top of the head of the speaker 2, or, more generally, information about the location and the size of the halo 4. Advantageously, also an area 6 is identified in the metadata, which specifies where in the scene 1 the sub-title 3 may be placed. The area 6 may be the same for both persons in the scene 1. The most appropriate location is advantageously determined by the set top box 10 based on the available information, especially the location information conveyed by the arrow or vector 5.

Yet another solution for a visual hint is depicted in FIG. 4. Here lines 7 are drawn around the mouth or other sound sources to suggest sound waves. The lines 7 may likewise be drawn around the whole head. Here, more detailed metadata about the precise location and shape of the lines 7 are necessary, as illustrated in FIG. 5. An arrow or vector 5 specifies the source of the sound waves 7 at the speaker's mouth, the orientation of the sound waves 7, e.g. towards the listener, and the size of the sound waves 7. Again, an area 6 specifies where in the scene 1 the sub-title 3 may be placed.

The sound waves 7 may not only be used visualize speech, but also to make other sound sources visible, e.g. a car's hood if the car makes perceivable noise.

A further possibility for a visual hint is illustrated in FIG. 6. Here a corona or aura 8 is drawn around the speaker 2. The aura or corona 8 may pulse somewhat to visualize the words and to make the visualization simpler to recognize by the user. In addition, the speaker 2 may be lightened or brightened. For both cases detailed information about the shape of the speaking person 2 is necessary.

Of course, the above proposed solutions may be combined and the metadata advantageously includes the necessary information for several or even all solutions. The user then has the possibility to choose how the speakers or other sound sources shall be identified.

A method according to the invention for identifying a sound source in an image or a sequence of images is schematically illustrated in FIG. 7. A corresponding apparatus 10 is shown in FIG. 8. After retrieving 20 the image 1 or the sequence of images and retrieving 21 the metadata provided for the image 1 or the sequence of images via an input 30, a graphical identifier for the sound source is included 22 in the image 1 or the sequence of images. For this purpose the apparatus 10 comprises the appropriate means 31, e.g. a graphics processor. The information included in the metadata is used for determining where and how to include the graphical identifier in the image 1 or the sequence of images. The resulting image 1 or the resulting sequence of images is output 23 for display via a dedicated output 32.

A method according to the invention for generating metadata for identifying a sound source in an image or a sequence of images is schematically illustrated in FIG. 9. A corresponding apparatus 10 is shown in FIG. 10. The apparatus 10 has an input 30 for retrieving 20 the image 1 or the sequence of images. A user interface 33 enables a user to determine 24 at least one of information about a location of the sound source within the image 1 or the sequence of images, information about position and size of a graphical identifier for identifying the sound source, and shape of the sound source. The determined information is output as metadata for storage 25 on a storage medium 40, such as an optical storage medium or an internet storage solution 13, via an output 34.

As indicated above the metadata provided for an image 1 or a sequence of images may comprise an area 6 for placement of sub-titles 3 in addition to the information about the sound sources. Also the information about the sound sources constitutes a sort of sub-title related metadata, as it allows determining where in the specified area 6 a sub-title 3 is preferably placed. These metadata enable a number of further possibilities. For example, the user has the possibility to add sub-titles independent of the source content. He may download additional sub-titles from the internet storage solution 13 of the content provider 12 in real-time. Likewise, the user may generate his own sub-titles for own use or to make his work public for a larger community via the Internet. This is rather interesting especially for small countries without own audio synchronization. The sub-title area 6 allows to place the original sub-titles 3 at a different position than originally specified, i.e. more appropriate for the user's preferences. Of course, the allowed sub-title area 6 may also be specified by the user. Alternatively, the user may mark forbidden areas within the scene 1, e.g. in an interactive process, in order to optimize an automatic placement of sub-titles or other sub-pictures. The allowed or forbidden areas 6 may then be shared with other users of the content, e.g. via the internet storage solution 13 of the content provider 12.

For marking a part of the scene, e.g. one frame out of the scene, the superpixel method is preferably used, i.e. only superpixels need to be marked. This simplifies the marking process. The superpixels are either determined by the set top box 10 or made available as part of the metadata. The superpixel method is described, for example, in J. Tighe et al.: “Superparsing: scalable nonparametric image parsing with superpixels”, Proc. European Conf. Computer Vision, 2010. Furthermore, inside the same take the marked areas are advantageously automatically completed for the temporally surrounding frames of this scene, e.g. by recognition of the corresponding superpixels in the neighboring frames. In this way a simple mechanism may be implemented for marking appropriate objects of a whole take and areas for placing sub-titles and projecting halos, auras and shockwaves requiring only a limited amount of user interaction.

These metadata may be contributed to the internet community by sending the generated metadata to an internet storage solution. Such metadata may also be used by the content provider himself for enhancing the value of the already delivered content and to get a closer connection to his content users. Usually, there is no direct link between content providers 12 and the user. With such offers by the content providers, i.e. free storage of metadata, sharing of user generated metadata, the content provider 12 gets directly into contact with the viewers.

1. A method for identifying a sound source in an image or a sequence of images to be displayed, the method comprising:
retrieving the image or the sequence of images;
retrieving metadata provided for the image or the sequence of images, the metadata comprising at least one of information about a location of the sound source within the image or the sequence of images, information about position and size of a graphical identifier for identifying the sound source, and shape of the sound source;
including a graphical identifier for the sound source in the image or the sequence of images using the information included in the metadata; and
outputting the image or the sequence of images for display.

2. The method according to claim 1, further comprising receiving a user input to identify a sound source in the image or the sequence of images.

3. The method according to claim 1, wherein the graphical identifier is at least one of a halo located above the sound source, an aura arranged around the sound source, and a sequence of schematically indicated sound waves.

4. The method according to claim 1, wherein the metadata are retrieved from a local storage and/or a network.

5. An apparatus for playback of an image or a sequence of images, wherein the apparatus comprises:
an input configured to retrieve the image or the sequence of images and to retrieve metadata provided for the image or the sequence of images, the metadata comprising at least one of information about a location of the sound source, information about position and size of a graphical identifier for identifying the sound source, and shape of the sound source;
means configured to include a graphical identifier for the sound source in the image or the sequence of images using the information included in the metadata; and
an output configured to output the image or the sequence of images for display.

6. A method for generating metadata for identifying a sound source in an image or a sequence of images to be displayed, the method comprising:
determining at least one of information about a location of the sound source within the image or the sequence of images, information about position and size of a graphical identifier for identifying the sound source, and shape of the sound source; and
storing the determined information as metadata for the image or the sequence of images on a storage medium.

7. An apparatus for generating metadata for identifying a sound source in an image or a sequence of images to be displayed, wherein the apparatus comprises:
a user interface configured to determine at least one of information about a location of the sound source within the image or the sequence of images, information about position and size of a graphical identifier for identifying the sound source, and shape of the sound source; and
an output configured to store the determined information as metadata for the image or the sequence of images on a storage medium.

8. A storage medium, wherein the storage medium comprises at least one of information about a location of a sound source within an image or a sequence of images, information about position and size of a graphical identifier for identifying a sound source in an image or a sequence of images, and shape of a sound source in an image or a sequence of images.

9. The storage medium according to claim 8, wherein the storage medium further comprises the image or the sequence of images.
